(19) United States
(12) Patent Application Publication
(10) Pub. No.: US 2026/0188946 A1
(43) Pub. Date: Jul. 2, 2026

(54) CONNECTOR AND DEVICE USING SAME

(71) Applicant: NINGBO DEGSON ELECTRICAL CO., LTD., Zhejiang (CN)

(72) Inventors: Gaosong DING, Zhejiang (CN); Yuhui BA, Zhejiang (CN); Guifan LAN, Zhejiang (CN); Chunhua LAN, Zhejiang (CN)

(21) Appl. No.: 19/126,049

(22) PCT Filed: Mar. 3, 2023
(86) PCT No.: PCT/CN2023/079594

§ 371 Date: Apr. 30, 2025

(30) Foreign Application Priority Data
Nov. 7, 2022 (CN) 202222983999.9

(51) Int. Cl. H01R 13/627; H01R 12/70; H01R 13/621

(52) U.S. Cl. CPC H01R 13/6272; H01R 12/7082; H01R 13/6215

(57) ABSTRACT

A connector housing (1) is provided with a receiving portion (2) for receiving a connector (A) and a relatively narrow cable lead-out portion (4) extending from a shoulder portion (3) formed at the rear end thereof. A locking screw (8) for locking a connector (B) is inserted into a side face of the receiving portion (2) of the connector housing (1). When an operating portion (10b) which is arranged at the rear end of a locking piece (10) and exposed out of the outer surface of the cable lead-out portion (4) is pressed, the locking piece (10) swings against the elastic force of a tongue piece (10d), thereby releasing the engagement of a claw portion (10a) thereof with the connector (B). The tongue piece (10d) abuts against the locking screw (8), and the front end of the locking piece (10) is formed into a forked shape to avoid interference with the locking screw (8).

[Effect]

Even if the respective connector housings are arranged such that their receiving portions are in contact with each other, the operating portion of the locking piece can still be operated, which enables the arrangement pitch of the connector housings to be narrower, thus making the arrangement of these housings more compact. By using the locking screw also as a reaction support for the tongue piece, the width of the connector housing can be reduced.

### TECHNICAL FIELD

The present utility model relates to a connector housing with a locking mechanism, which can receive one of a male connector and a female connector.

### BACKGROUND

As shown in FIG. 5, Japanese Utility Model Publication No. S52-9058 discloses such a known connector housing. The connector housing is provided with a connector receiving portion a and a relatively narrow cable lead-out portion c; the connector receiving portion a is provided with an opening at a front end thereof, the opening being used for connecting one connector A of the male and female connectors received therein to the other connector B thereof; the cable lead-out portion c extends from a shoulder portion b formed at a rear end of the connector housing a and is used for guiding a cable to be wired to the one connector A. A locking screw d that can be screwed into the other connector B is inserted into a side face of the connector receiving portion a through the shoulder portion b, and a locking piece e is further provided; a front end of the locking piece e is provided with a claw portion e1 capable of engaging with the other connector B from a lateral outer side, a rear end of the locking piece e is provided with an operating portion e2 exposed out of the outer surface of the connector housing; the locking piece e can swing inward in the lateral direction with a middle portion e3 thereof as a fulcrum; the other connector B is double-locked by both the locking screw d and the locking piece e, thereby reliably preventing the other connector B from being disconnected.

In this apparatus, the locking piece e is mounted in a groove portion f formed on the lateral outer side of the insertion position of the locking screw d. The operating portion e2 at the rear end of the locking piece e is exposed out of the lateral outer surface of the connector receiving portion a, and a tongue piece e4 is cut and raised near the rear end of the fulcrum portion e3 in the middle of the locking piece e, the tongue piece e4 elastically abutting against a groove wall on the lateral inner side of the groove portion f. When the operating portion e2 is pressed toward the lateral inner side, the front end of the locking piece e swings toward the lateral outer side against the acting force of the tongue piece e4, thereby releasing the engagement of the claw portion e1 with the other connector B.

### SUMMARY OF THE UTILITY MODEL

### Technical Problem to be Solved by the Utility Model

In the above-mentioned existing connector housing, the operating portion e2 of the locking piece e is exposed out of the lateral outer surface of the relatively wide connector receiving portion a, which increases the overall width of the connector housing including the operating portion e2. When a plurality of connectors B are arranged in a power distribution portion of an NC processing device and connected to each connector A, the arrangement pitch in the width direction of the connector housing of each connector A must be large to leave an operating space for the operating portion e2. This requires the arrangement pitch of the connectors B to also be increased, resulting in an increase in the size of the power distribution portion. In view of the above situation, an objective of the present utility model is to provide a connector housing which can reduce the overall width of the housing and allow the housings to be arranged as closely as possible.

### Technical Solutions Adopted to Solve the Technical Problem

To achieve the above objective, the present utility model provides a connector housing for receiving one of a male connector and a female connector, characterized in that the connector housing comprises: a connector receiving portion and a relatively narrow cable lead-out portion; a front end of the connector receiving portion is provided with an opening for connecting one connector to the other connector; the cable lead-out portion extends from a shoulder portion formed at a rear end of the connector receiving portion and is used for guiding a cable to be wired to the one connector; a locking screw that can be screwed into the other connector is inserted into a side face of the connector receiving portion through the shoulder portion; and a locking piece is further provided, a front end of the locking piece is provided with a claw portion capable of engaging with the other connector from a lateral outer side, a rear end of the locking piece is provided with an operating portion exposed out of the outer surface of the connector housing, and the locking piece can swing with a middle portion thereof as a fulcrum such that the front end thereof can swing toward a lateral inner side; wherein the locking piece is arranged on the lateral inner side of the insertion position of the locking screw, and the operating portion at the rear end of the locking piece is exposed out of a lateral outer surface of the cable lead-out portion.

### Effects

Since the locking piece is arranged on the lateral inner side of the insertion position of the locking screw, the rear end thereof can extend through the inner side of the housing shoulder portion to the cable lead-out portion, and an operating portion is provided at this extended end to be exposed out of the lateral outer side of the cable lead-out portion. In addition, since the cable lead-out portion is recessed inward in the lateral direction relative to the connector receiving portion, the operating portion of the locking piece can be constrained within the width range of the connector receiving portion, thereby reducing the overall width compared with the existing connector housing in which the operating portion of the locking piece is exposed out of the lateral outer side of the connector receiving portion. Moreover, even if the respective connector housings are arranged such that the side surfaces of the connector receiving portions are in contact with and close to each other, the operating portion of the locking piece can still be easily pressed and operated within the space that is ensured between the cable lead-out portions of the respective connector housings.

In addition, like in the prior art, a tongue piece can be cut and raised on the locking piece for elastically abutting against the groove wall of the groove portion where the locking piece is mounted, so that the front end of the locking piece tends to swing toward the lateral inner side. However, this requires a wider groove portion, which would increase the width of the connector housing.

On the contrary, if the tongue piece is cut and raised at a position on the locking piece that is closer to the front end than the fulcrum portion in the middle, and the tongue piece is made to elastically abut against the peripheral surface of the locking screw from the lateral inner side thereof, then the space of the groove wall thickness between the groove portion and the locking screw can be used as a deflection space for the tongue piece, and thus a sufficient deflection space can be ensured even if the groove width is narrowed. With this structure, when the operating portion is pressed, the tongue piece is squeezed to generate elastic deformation with the locking screw as a reaction support, so that the front end of the locking piece swings toward the lateral outer side, thereby releasing the engagement of the claw portion with the other connector.

In addition, as mentioned above, when the width of the groove portion is narrowed, the gap between the locking piece and the locking screw is also narrowed, and when the operating portion is pressed to make the front end of the locking piece swing toward the lateral outer side, the front end would interfere with the locking screw. Therefore, the front end is formed into a forked shape, wherein a projection portion thereof in a direction toward the lateral inner side of the locking screw is cut off, so as to prevent the front end from interfering with the locking screw.

### BRIEF DESCRIPTION OF THE DRAWINGS

FIG. 1 is a partially cut-away front view of an example of the connector housing of the present application.

FIG. 2 is a side view cut along line II-II of FIG. 1.

FIG. 3 is a perspective view of the locking piece.

FIG. 4 is a perspective view showing the relationship between the connector housing of the present application and a mating connector.

FIG. 5 is a partially cut-away front view of an existing example.

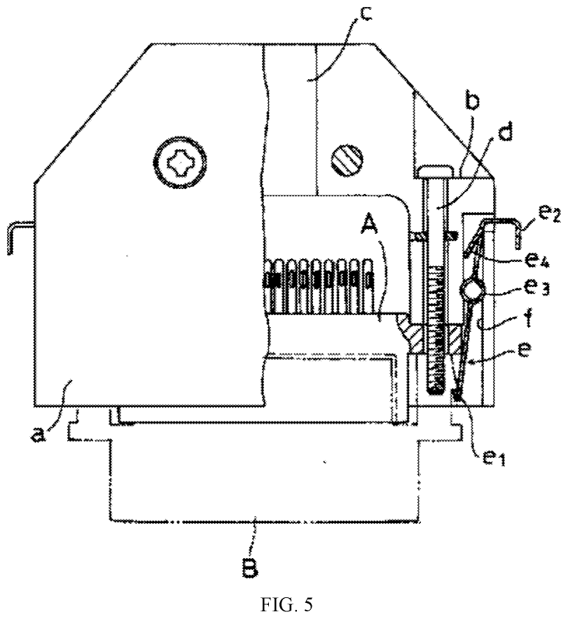

### REFERENCE NUMERALS

1. Connector housing
2. Connector receiving portion
3. Shoulder portion
4. Cable lead-out portion
8. Locking screw
10. Locking piece
10a. Claw portion
10b. Operating portion
10c. Fulcrum portion
10d. Tongue piece

### DETAILED DESCRIPTION OF EMBODIMENTS

### Embodiments

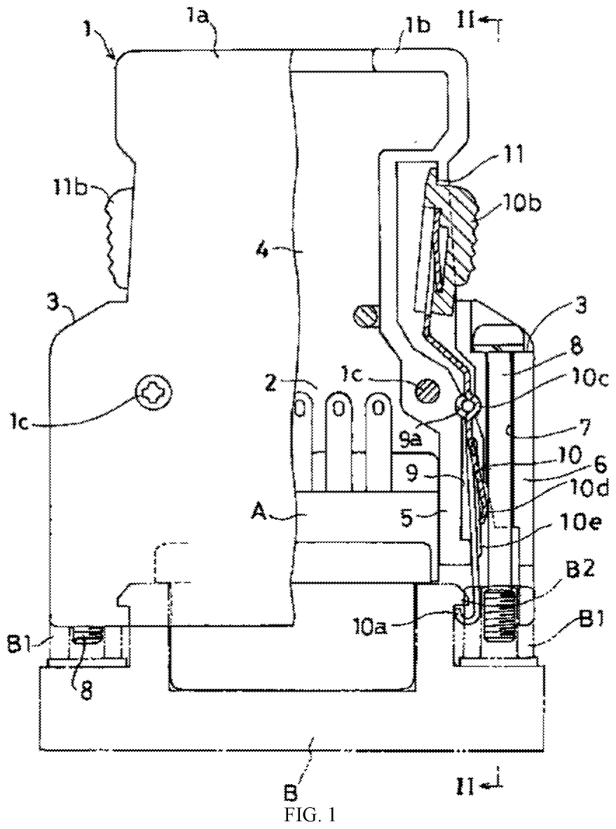

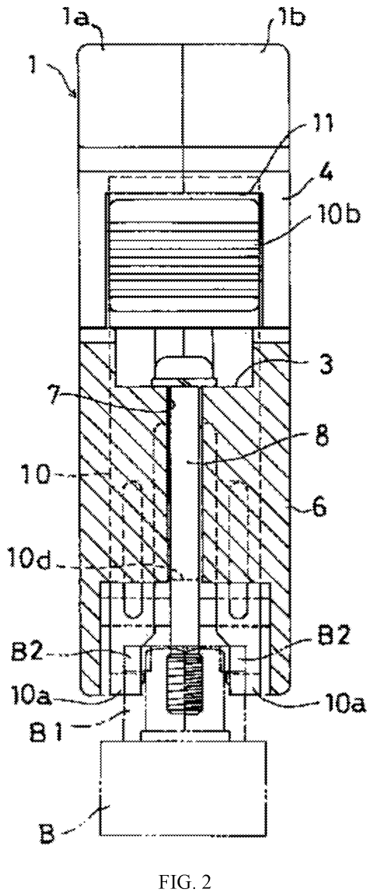

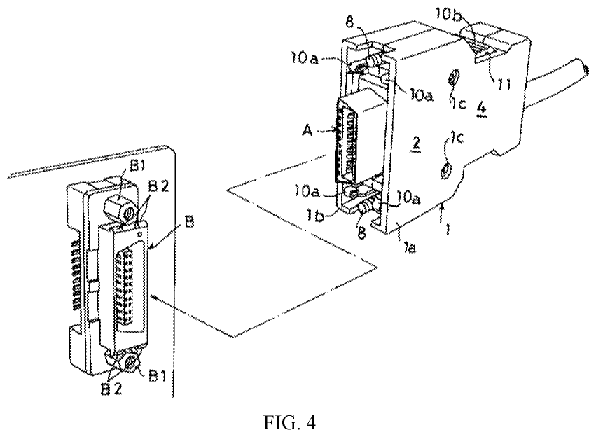

In FIG. 1, FIG. 2 and FIG. 4, reference numeral 1 denotes a connector housing formed by fixing a pair of opposite half-housings 1a and 1b with screws 1c. The housing 1 is provided with a connector receiving portion 2 for receiving one connector A of the male and female connectors and a relatively narrow cable lead-out portion 4 extending from a shoulder portion 3 formed at the rear end of the receiving portion 2; the cable lead-out portion 4 is used for guiding a cable to be wired to the connector A; a front end of the connector receiving portion 2 is open, so that a mating connector B that matches the connector A can be fittingly connected to the connector A through the front end opening.

A side face of the connector receiving portion 2 is composed of double walls including an inner wall 5 and an outer wall 6. A vertical hole 7 extending all the way to the shoulder portion 3 is formed in the outer wall 6, and a locking screw 8 is inserted into the vertical hole 7 from the side of the shoulder portion 3; at the same time, a locking piece 10 formed of a leaf spring is mounted in a groove portion 9 between the inner wall 5 and the outer wall 6. When the connector B is connected to the connector A, the locking screw 8 is screwed into a nut B1 implanted in the connector B, and a claw portion 10a at the front end of the locking piece 10 engages with a jaw portion B2 formed on the connector B from the lateral outer side, thereby achieving double locking for the connector B.

The rear end of the locking piece 10 passes through the inner side of the shoulder portion 3 and extends to the cable lead-out portion 4. An operating portion 10b made of resin is attached to the rear end thereof, and the operating portion 10b is exposed to the outside through a window 11 formed on a side surface of the cable lead-out portion 4.

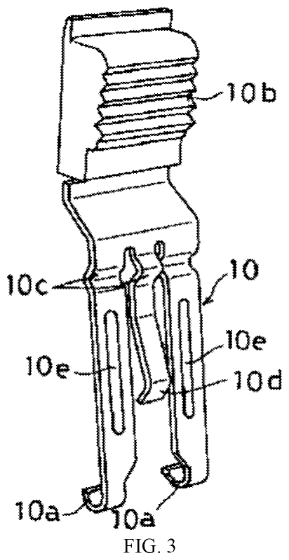

In addition, as shown in FIG. 3, an arc-shaped fulcrum portion 10c protruding both inward and outward is formed in the middle of the locking piece 10, and the fulcrum portion 10c engages with an arc-shaped recessed portion 9a formed in the groove portion 9. When the operating portion 10b is pressed toward the lateral inner side, the locking piece 10 swings around the fulcrum portion 10c as a center, and the front end portion thereof moves toward the lateral outer side, making the claw portion 10a disengage from the above-mentioned jaw portion B2, thereby releasing the engagement thereof with the connector B.

A tongue piece 10d cut and raised toward the lateral outer side is further provided on the locking piece 10, and the tongue piece 10d is located at a position closer to the front end than the fulcrum portion 10c. A surface portion of the outer wall 6 on the side of the groove portion 9 is beveled at a location corresponding to the tongue piece 10d so as to expose the locking screw 8 at this location, and the tongue piece 10d elastically abuts against the peripheral surface of the locking screw 8 from the lateral inner side thereof. The elasticity of the tongue piece 10d urges the locking piece 10 to swing, making the front end portion thereof move toward the lateral inner side, so that the claw portion 10a will not disengage from the jaw portion B2 unless the operating portion 10b is pressed. However, in the case that the surface of the outer wall 6 on the side of the groove portion 9 is not beveled and the tongue piece 10d is to abut against this surface, in order to ensure the same deflection space for the tongue piece 10d as in this embodiment, the width of the groove portion 9 must be widened by a corresponding wall thickness on the inner side of the locking screw 8 that is inserted in the outer wall 6, and the outer wall 6 must correspondingly be shifted outward by this distance, which would lead to an increase in the width of the connector housing 1, however, in comparison, this problem would not occur in this embodiment.

The front end of the locking piece 10 is formed into a forked shape, wherein a projection portion thereof in a direction toward the lateral inner side of the locking screw 8 is cut off, so as to prevent interference with the locking screw 8 when swinging outward in the lateral direction. The claw portion 10a is formed at each front end of the forked portion. In this embodiment, a continuous cut is formed and extends at the slit for cutting and raising the tongue piece 10d, and the width of the cut between the front ends of the forked portion is slightly widened to avoid interference with the nut B1 of the connector B. Reference numeral 10e in the figure denotes a reinforcing rib formed on the forked portion.

### Advantages of the Utility Model

As mentioned above, according to the utility model as claimed in claim 1, when a plurality of connector housings are arranged in a row along the width direction, even if the respective connector housings are arranged such that their connector receiving portions are in contact with each other, the operating portion of the locking piece can still be exposed out of the lateral outer side of the cable lead-out portion which is narrower than the connector receiving portion, so that the operation of the operating portion is not hindered. This enables the arrangement pitch of the connector housings to be narrower, thus making the power distribution portion where these connector housings are arranged in a row more compact. In addition, according to the utility model as claimed in claim 2, the width of the connector receiving portion of the connector housing can be further reduced, thereby achieving a more compact structure.

1. A connector, characterized in comprising:
a first plug-in component (1), provided with an engagement portion;
a second plug-in component (2), detachably connected to the first plug-in component (1), wherein the second plug-in component (2) is provided with at least one locking tongue (203) configured to lock the first plug-in component (1) and the second plug-in component (2) together, the locking tongue (203) is adapted to the engagement portion;
at least one unlocking member (3), detachably connected to the second plug-in component (2), wherein the unlocking member (3) is provided with an abutting portion (304), the connector has a first state in which the locking tongue (203) and the engagement portion are locked together; and a second state in which pressure is applied to the unlocking member (3) to drive the abutting portion (304) to move the locking tongue (203) away from the engagement portion until the locking tongue (203) becomes separated from the engagement portion.

2. The connector according to claim 1, characterized in further comprising a fastener (4), wherein the first plug-in component (1) is provided with a fastening end (103), the second plug-in component (2) is provided with a first through-hole (201) corresponding to the fastening end (103), and the unlocking member (3) is provided with a pivoting portion (303), the pivoting portion (303) is provided with an accommodation space (305) configured to allow passage of the fastener (4), wherein the fastener (4) is configured to sequentially pass through the first through-hole (201) and the accommodation space (305) to be fixedly connected to the fastening end (103), thereby fixedly connecting the first plug-in component (1) and the second plug-in component (2) to each other.

3. The connector according to claim 2, characterized in that the fastener (4) comprises a fastening rod (401) adapted to the fastening end (103) and an abutting plate (402) fixedly connected to the fastening rod (401), the fastening end (103) is provided with a fastening ring, and the fastening rod (401) is in threaded connection with the fastening ring.

4. The connector according to claim 3, characterized in that a central axis of the first through-hole (201), a central axis of the accommodation space (305) of the pivoting portion (303), and a central axis of the fastening end (103) are coaxially arranged.

5. The connector according to claim 2, characterized in that the locking tongue (203) extends toward the second plug-in component (2) to form a first elastic plate (202), the first elastic plate (202) is fixedly connected to the second plug-in component (2), a free end of the first elastic plate (202) is the locking tongue (203), a clamping surface of the locking tongue (203) is a first inclined surface (204), and a corresponding clamping surface of the engagement portion is a second inclined surface (102) adapted to the first inclined surface (204).

6. The connector according to claim 5, characterized in that one end of the first plug-in component (1) is provided with an accommodation groove (101), and one end of the accommodation groove (101) adjacent to a locking portion of the second plug-in component (2) is provided with the engagement portion.

7. The connector according to claim 5, characterized in that one end of the pivoting portion (303) of the unlocking member (3) in connection with a pressing portion (301), and an opposite end thereof is in connection with the abutting portion (304), and the pressing portion (301) is disposed outside the second plug-in component (2).

8. The connector according to claim 7, characterized in that the second plug-in component (2) is provided with an accommodation cavity (205) adapted to the unlocking member (3), the accommodation cavity (205) accommodates the pivoting portion (303) and the abutting portion (304), and the abutting portion (304) abuts against the first elastic plate (202).

9. The connector according to claim 8, characterized in that an elastic element is disposed between the accommodation cavity (205) and the accommodation space (305) of the pivoting portion (303).

10. A device equipped with a connector, characterized in comprising the connector according to claim 1, and further comprising a PCB board, wherein the first plug-in component (1) is fixedly disposed on the PCB board.
